(19) United States
(12) Patent Application Publication
(10) Pub. No.: US 2007/0193681 A1
(43) Pub. Date: Aug. 23, 2007

(54) Method of Calibrating a Printing Apparatus

(75) Inventors: Mark Smith, Groby (GB); Paul Hammond, East Leake (GB)

Correspondence Address: FISH & RICHARDSON PC, P.O. BOX 1022, MINNEAPOLIS, MN, 55440-1022, US

(73) Assignee: MARKEM TECHNOLOGIES LIMITED, Nottingham (GB)

(21) Appl. No.: 11/672,641

(22) Filed: Feb. 8, 2007

(30) Foreign Application Priority Data
Feb. 15, 2006 (GB) 0603022.5

(51) Int. Cl. B32B 38/14; B32B 37/00

(52) U.S. Cl. 156/277; 156/249; 156/64

(57) ABSTRACT

A method of calibrating a printing apparatus which includes a transport mechanism for transporting patches such as labels or RFID tags, each carried on a continuous backing web in a feed direction, from a store to and through a printing station, past a print head which is operative to print information on the patches, there being a patch removal mechanism for removing the printed patches from the backing web, the method including feeding a patch on the backing web in a direction opposite to the feed direction, from a position downstream of the print head, to a start position relative to the print head, and then advancing the patch again to test that the information is printed at a desired position on the patch.

### BACKGROUND TO THE INVENTION

This invention relates to a method of calibrating a printing apparatus of the kind which includes a transport mechanism for transporting patches each carried on a continuous backing web, in a feed direction, from a store to and through a printing station, past a print head. The print head is in use operative to print information on the patches, there being a patch removal mechanism for removing the printed patches from the backing web. The printed and removed patches subsequently are fed from the printing apparatus, for example to a patch applying mechanism, which may be operated to apply the printed patches to articles.

The patches may be simple labels on which information may be printed, or radio frequency identification devices (“RFIDs”), for examples only, and the articles may be packages or other items, for example which are conveyed in a production or packaging facility.

Such patches typically include a face to which an adhesive is applied, the adhesive adhering the patches to the continuous backing web, the backing web surface to which the patches are adhered readily releasing the patches to permit the patch removal mechanism to remove the labels.

### DESCRIPTION OF THE PRIOR ART

In calibrating such an apparatus, the transport mechanism and the print head need to be co-ordinated so that the print head begins printing on a patch with the patch at an aligned position relative to the head. Typically this is achieved with the apparatus operating in a calibration mode, when one or more test patches are fed by the transport mechanism past the print head, and then adjustments are made to the transport mechanism to co-ordinate the start of printing with a patch being correctly aligned with print head. Such adjustments may be made by manually advancing the backing web, or more typically by providing input to a controller which controls the transport mechanism.

In each case, with known arrangements, patches are fed in the feed direction fed from the printing apparatus 10 and discarded while calibration is being effected. Where the printing apparatus is a high speed apparatus, this can result in a significant number of patches being wasted during calibration, and moreover, as such patches will adhere to any surface with which the adhesive comes into contact, the discarding of several patches can resulting in patches undesirably becoming adhered to surfaces.

It has been proposed to provide a patch removal mechanism which can be rendered inoperative so that defective patches (particularly RFIDs) are nor removed from the backing web. For example, the patch removal mechanism may include a beak to encourage the removal of patches from the backing web, which beak may be moved to an inoperative position to allow a defective tag to be transported to a take-up store with backing web.

Whereas the use of such patch removal mechanism which can be rendered inoperative, may overcome the problem of “sticky” patches being fed from the apparatus, patches are still wasted, and particularly if the patches are RFIDs, such wastage can be expensive.

### SUMMARY OF THE INVENTION

According to a first aspect of the invention we provide a method of calibrating a printing apparatus which includes a transport mechanism for transporting patches each carried on a continuous backing web in a feed direction, from a store to and through a printing station, past a print head which is operative to print information on the patches, there being a patch removal mechanism for removing the printed patches from the backing web, the method including feeding a patch on the backing web in a direction opposite to the feed direction, from a position downstream of the print head, to a start position relative to the print head, and then advancing the patch again to test that the information is printed at a desired position on the patch.

Thus the wastage of patches during calibration may be at least reduced.

Desirably the patch removal mechanism is rendered inoperative during calibration so that printed patches may be advanced past the print head and patch removal mechanism in the feed direction to the downstream position on the backing web, and then fed in the direction opposite to the feed direction to bring a patch to the start position.

Thus one only or a small number of patches may be wasted during calibration and “sticky” patches are not fed from the apparatus but the patches are retained adhered to the backing web during calibration.

The patch removal mechanism may include a peeler member which may include a roller with a beak, the backing web being entrained about the peeler member, the condition of the peeler member being changeable from an operative condition in which a patch adhered to the backing web is removed from the backing web, to an inoperative position in which condition the peeler member is inoperative to remove patches from the backing web.

Thus the method may include changing the condition to an inoperative condition during apparatus calibration, for example by rotating the peeler member where a roller and beak, from an operative condition.

The transport mechanism may feed the backing web and hence the patches to and through the printing station in the feed direction by rotating a backing web take-up spool which draws backing web and patches adhered thereto from a storage spool, or preferably by driving both storage and take-up spools simultaneously. The method may include driving at least the storage spool to feed the backing web and patches in a direction opposite to the feed direction to bring a patch to the start position.

In another example the transport mechanism may include a capstan roller about which the backing web may be entrained, the method including rotating the capstan roller in a first direction of rotation to feed the backing web and patches in the feed direction, and for calibration, rotating the capstan roller in an opposite direction of rotation to bring a patch to the start position.

In each case the apparatus may include a sensor to sense the position of a patch relative to the print head, thereby to provide a reference indication of the relative position of a patch to the print head for use in arranging for the information to be printed at the desired position on the patch.

For example only, such a sensor may sense the leading edge of a test patch at or adjacent the printing station, e.g. as the patch is fed past the print head, both prior to feeding the patch back past the print head to the start position and subsequently.

The printing apparatus may be a thermal printing apparatus in which the print heat includes an array of printing elements which are individually energisable under computer control to remove pixels of marking medium such as ink, from a carrier such as a ribbon. Thus the apparatus may include a carrier transport system for moving carrier relative to the print head during printing.

### BRIEF DESCRIPTION OF THE DRAWINGS

Embodiments of the invention will now be described with reference to the accompanying drawings in which:

FIG. 1 is an illustrative side view of a printing apparatus operated in accordance with the method of the present invention, during normal printing mode;

FIG. 2 is a view similar to that of FIG. 1 but showing the apparatus during calibration mode.

### DESCRIPTION OF THE PREFERRED EMBODIMENTS

Referring to the drawings there is shown a printing apparatus 10 which includes a print head 12 for printing information on patches which in this example are simple labels 14 but could in another example be RFID tags.

The labels 14 are each adhered to a continuous backing web 15 which is provided on a storage spool 16, the backing web 15 passing around a path past and through a printing station 18 where the print head 12 is provided, and hence to a label removing mechanism 19, and then to a take-up spool 20.

In the present example, the printing apparatus 10 is of the kind in which the print head 12 includes an array 13 of individually and selectively energisable printing elements which when energised, heat up each remove a pixel of marking medium i.e. ink, from a carrier 22 which is an inked ribbon in this example, to print information. The removed pixels of ink are deposited on a substrate such as a label 14 which passes between the print head 12 and a backing member such as the backing roller 17 in the example shown.

Thus the apparatus 10 in this example includes a carrier transport system including a carrier storage spool 26 and a used carrier take-up spool 27, there being some drive means, for example to drive one or both of the carrier spools 26, 27 or directly to drive the carrier 22 as required.

Printing is effected and co-ordinated under the control of a controller 30 which operates a backing web 15 drive to move the backing web 15 and labels 14 to and past the print head 12, and to move the inked carrier 22, whilst selectively energising the printing elements of the print head 12 to effect the printing of information on the labels 14.

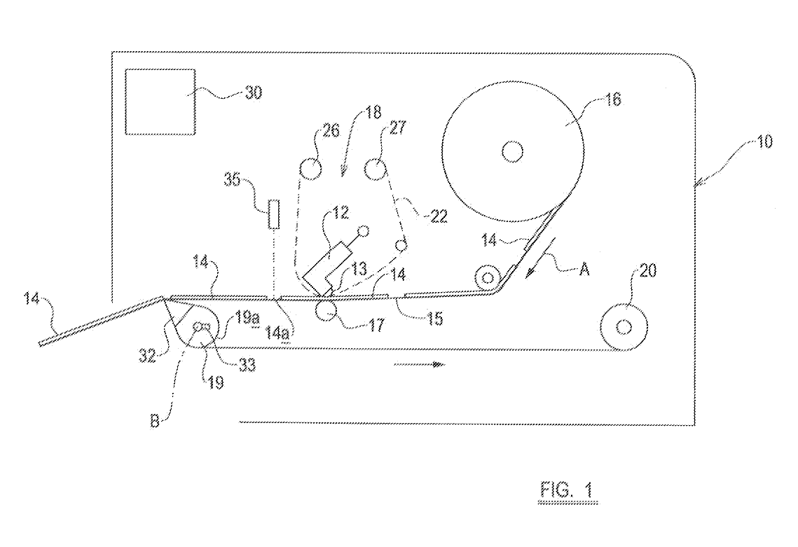

In this example, the backing web 15 may be driven in a feed direction indicated in FIG. 1 by arrow A by rotating the take-up spool 20 to draw backing web 15 and labels 14 from the storage spool 16. In another example, both the storage 16 and take-up 20 spools may simultaneously be driven to effect tension control in the backing web 14, or in another example, the backing web 15 may be entrained about a capstan roller which is rotated to drive the backing web 15 and patches 14, in the feed direction A.

The label removing mechanism 19 includes in this example, a peeler member which includes a round roller surface 19a and a beak 32. The peeler member 19 is rotatable as described below, to a condition in which it is inoperative to remove labels 14 from the backing web 15. However in FIG. 1, the peeler member 19 is operative to remove printed labels 14 from the backing web 15, which are fed thereto from the printing station 18 on the backing web 15.

The labels 14 each have a face which is coated with an adhesive which adheres removeably to a release surface, such as a waxed surface, of the backing web 15. As the backing web 15 is advanced around the beak 32, by virtue of the labels 14 being less flexible than the backing web 15, the sharp change in direction causes the labels 14 to be peeled from the backing web 15, and the labels 14 may then be fed from the printing apparatus 10, for example to a label applying apparatus.

It will be appreciated, that depending on the nature of the information to be printed upon the labels 14, the print head 12 and labels 14 need to be aligned at the start of printing so that the information is printed in a desired position on the label 14. Thus upon set-up, the apparatus 10 needs to be calibrated.

A sensor 35 is provided to sense a leading edge 14a of a label 14, for example using optical technology, to provide a reference label position. Hence the apparatus 10 requires calibrating to ensure that the print head 14 starts printing at a desired position along the label 14 from the leading edge 14a, as the label 14 is transported past the print head 12.

It will be appreciated that labels 14 may be advanced in the feed direction A at high speed e.g. several labels 14 a second may be printed and advanced past the print head 12 and at least in the FIG. 1 configuration with the peeler member 19 operative, during a test or calibration run, several labels 14 may be peeled from the backing web 15 and fed from the printing apparatus 10. This is undesirable both from the point of view of wastage, particularly where, instead of labels, the patches 14 are RFID tags more expensive than labels 14, but also because the peeled labels 14 will be sticky and may adhere undesirably to surfaces.

In accordance with the invention, rather than discarding labels 14 during calibration, after feeding test the labels 14 in the feed direction A past the print head 12, the labels 14 are brought back, in a direction opposite to the feed direction, to a position which may be upstream of the print head 12, and fed again in the feed direction A once any calibration adjustments have been made. Thus test labels 14 are not fed from the apparatus 10.

To achieve this in the embodiment shown, the take-up spool 20, or the take-up and storage spools 20, 16 may be driven in an opposite direction to that in which the spool or spools is/are driven during label 14 advancement. In a capstan drive arrangement, the capstan drive roller may be driven in an opposite direction. In each case, previously printed labels 14 are brought for subsequent re-use on a further test printing run, and repositioned at a start position at or upstream of the print head 12.

Moreover, the condition of the patch removal mechanism, i.e. the peeler member 19, is changed to be inoperative to remove the labels 14 from the backing web 15.

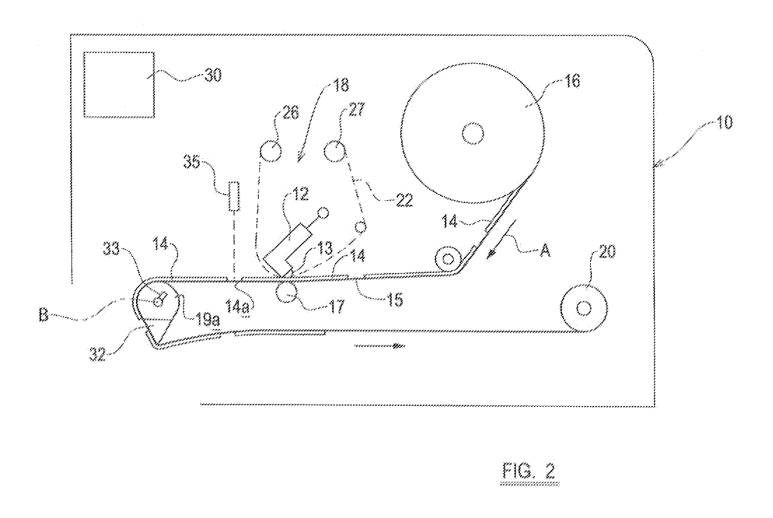

In the FIG. 1 condition, the peeler member 19 is held in the rotational position shown in which the beak 32 acts to peel the labels 14 from the web 15 as the web 15 passes around the peeler member 19. This may be achieved by moving an actuator (not shown) e.g. into the path of a stop 33 which would otherwise rotate with the peeler member 19 about an axis of rotation B. In FIG. 2 though, the actuator has been moved out of the path of the stop 33 and consequently, by virtue of frictional engagement between the roller surface 19a of the peeler member 19 and the backing web 15, the peeler member 19 will rotate about its axis of rotation B with the result that the labels 14 will not be peeled from the backing web 15 but will be fed downstream of the peeler member 19.

When it is desired to feed labels 14 back e.g. to start positions upstream of the print head 12 or at least adjacent the print head 12, the stop 33 may remain released by the actuator so that the peeler member 19 may rotate as the backing web 15 and labels 14 are moved back.

The point at which the print head 12 is caused to start printing with respect to a label 14 may be adjusted by making manual adjustments, but preferably by an operator providing input to the controller 30. After effecting adjustments, another test run may be carried out on the same, or at least some of the same labels 14 as were used in the original test run.

When an operator is satisfied that the print head 12 is printing the information on the labels 14 at desired positions of the labels 14, the actuator may be moved again into the path of the stop 33 of the peeler member 19, so that the peeler member 19 rotation will be arrested in the FIG. 1 position, at which the peeler member 19 is again operative to remove printed labels 14 from the backing web 15 so that the labels 14 may be fed from the apparatus 10.

Various modifications in addition to those already mentioned may be made without departing from the scope of the invention.

For example the invention need not only be applied to a printing apparatus 10 of the thermal kind, but may be applied to any other kind of printing apparatus, such as for examples only, an ink-jet type printing apparatus or a laser printing apparatus, in which case the carrier spools 26, 27 and carrier transport system would not be required.

Although it is preferred for the condition of the peeler member 19 to be changed as described, various other means for rendering the peeler member 19 or other patch removing mechanism inoperative when it is desired not to remove labels 14 or other patches from the backing web 15 at least during apparatus 10 calibration, may be provided.

1. A method of calibrating a printing apparatus which includes a transport mechanism for transporting patches each carried on a continuous backing web in a feed direction, from a store to and through a printing station, past a print head which is operative to print information on the patches, there being a patch removal mechanism for removing the printed patches from the backing web, the method including feeding a patch on the backing web in a direction opposite to the feed direction, from a position downstream of the print head, to a start position relative to the print head, and then advancing the patch again to test that the information is printed at a desired position on the patch.

2. A method according to claim 1 wherein the patch removal mechanism is rendered inoperative during calibration so that printed patches are advanced past the print head and patch removal mechanism in the feed direction to the downstream position on the backing web, and then fed in the direction opposite to the feed direction to bring a patch to the start position.

3. A method according to claim 2 wherein the patch removal mechanism includes a peeler member, the backing web being entrained about the peeler member, the method including changing the condition of the peeler member from an operative condition in which a patch adhered to the backing web is removed from the backing web, to an inoperative condition in which the peeler member is inoperative to remove patches from the backing web.

4. A method according to claim 3 wherein the peeler member includes rotating the peeler member to change the operating condition of the peeler member from an operative condition in which a patch adhered to the backing member is removed from the backing web, and an inoperative position in which condition the peeler member is inoperative to remove patches from the backing web.

5. A method according to claim 1 wherein the transport mechanism feeds the backing web and hence the patches to and through the printing station in the feed direction by rotating a backing web take-up spool which draws backing web and patches adhered thereto from a storage spool.

6. A method according to claim 5 in which the method includes driving the storage spool to feed the backing web and patches in a direction opposite to the feed direction to bring a patch to the start position.

7. A method according to claim 5 wherein the method includes driving both storage and take-up spools simultaneously.

8. A method according to claim 1 wherein the apparatus includes a sensor to sense the position of a patch relative to the print head, the method including providing a reference indication of the relative position of a patch to the print head for use in arranging for the information to be printed at the desired position on the patch.

9. A method according to claim 8 wherein the sensor senses a leading edge of a test patch at or adjacent the printing station.

10. A method according to claim 1 wherein the printing apparatus is a thermal printing apparatus in which the print head includes an array of printing elements which are individually energisable under computer control to remove pixels of marking medium such as ink, from a carrier, the method including operating a carrier transport system for moving carrier relative to the print head during printing.
